(19) United States
(12) Patent Application Publication
(10) Pub. No.: US 2015/0224910 A1
(43) Pub. Date: Aug. 13, 2015

(54) TARPAULIN AND PRODUCTION PROCESS THEREOF

(71) Applicant: DYNATEX S.A., Mouscron (BE)

(72) Inventor: Christophe Callens, Beersel (BE)

(21) Appl. No.: 14/428,329

(22) PCT Filed: Sep. 17, 2013
(86) PCT No.: PCT/EP2013/069287

§ 371 Date: Mar. 13, 2015

(30) Foreign Application Priority Data
Sep. 19, 2012 (EP) 12184939.2
Feb. 4, 2013 (EP) 13153904.1

(51) Int. Cl. B60P 7/04; B32B 7/08; D04H 3/147; D04H 3/12; B32B 37/20; B32B 37/26; B32B 38/00; D04H 3/10; B32B 5/12; D04H 3/153

(52) U.S. Cl. CPC B60P 7/04; B32B 5/12; B32B 7/08; D04H 3/147; D04H 3/153; B32B 37/20; B32B 37/26; B32B 38/0012; D04H 3/10; D04H 3/12; B32B 2255/02; B32B 2255/26; B32B 2262/0276; B32B 2038/008; B32B 2305/08; B32B 2305/18; B32B 2305/20

(57) ABSTRACT

The present invention is related to a laid fabric suitable to be transformed into a tarpaulin for covering freight trucks, trailers or trucks, more specifically to reinforced tarpaulins for the prevention of deformations during transport with freight trucks, trailers or trucks and the manufacture process of such tarpaulins.

### TECHNICAL FIELD

The present invention is related to a laid fabric suitable to be transformed into a tarpaulin for covering freight trucks, trailers or trucks, more specifically to reinforced tarpaulins for the prevention of deformations during transport with freight trucks, trailers or trucks and the manufacture process of such tarpaulins.

### BACKGROUND

Trucks with trailers attached to them are commonly employed for shipping on land. Tarpaulins are usually used to cover the roof and the sides of trailers to protect and prevent their cargos from falling off during transport. A disadvantage of the commonly used tarpaulins is their low rigidity as a result of which during transport undesirable deformations of the freight trucks may take place.

DE 197 56 865 and EP 1 387 775 describe roof constructions wherein such roof construction is additionally reinforced with several ropes or cables spanning the roof construction to enhance the rigidity. A disadvantage of these ropes or cables is that they are operated independently of the tarpaulin, for example when opening and closing the roof constructions.

WO 2007/110762, incorporated here by reference, describes a roof construction comprising a base fabric provided with a tarpaulin reinforcement means of a multi-axial and at least bi-axial layout of layers of mutually parallel extending reinforcement elements wherein the individual reinforcement element extends in a straight line from one edge to the other edge, i.e. it is provided at an angle different from 0° and 90° with respect to the longitudinal direction of the tarpaulin, without considerable deformations, which enhances the rigidity of the tarpaulin. The multi-axial reinforcement is added to a curtain fabric material (such as polyvinyl chloride curtain fabric) i.e. by hot welding, so that the resulting reinforced tarpaulin can be used as a roof stabilization system to prevent deformation of chargers, trailers and/or lorries. Welding two layers of the tarpaulin will reduce its flexibility as the final construction will be thick compared to a construction where the multi-axial reinforcement means are integrated into the polyvinyl chloride (PVC) curtain fabric.

Furthermore, in prior art tarpaulins and tarpaulin constructions it is also noticed that alteration of the layout of the reinforcement layer can be caused by a crimp of the base fabric, which leads to reinforcement threads not being completely straight and parallel any more in the layout. This is a problem, because the threads will not function as quickly as a reinforcement because when the roof is under tension by lateral forces, the threads will first be stretched before they will function as a stabilization element. This will reduce the efficiency of the stabilization function.

The present invention aims at providing a more cost efficient reinforced tarpaulin construction with a sufficiently high rigidity, which is dimensionally stable, as flexible as possible and as light-weighted as possible.

### SUMMARY OF THE INVENTION

The present invention provides a tarpaulin, comprising at least two web layers of reinforcement elements which extend mutually parallel in each web layer, preferably the bias directions of reinforcement elements in said two web layers are mutually opposite, preferably on the one hand at an angle between 0° and 90°, and on the other hand between −90° and 0° with regard to the longitudinal direction of the laid fabric, wherein said reinforcement elements are provided with a thermoplastic material coating, as described in claim 1.

In an embodiment of the present invention, said laid fabric comprises a supporting scrim provided at one side of said two web layers, as described in claim 2. Providing a supporting scrim at one side of said two web layers, will lead to a more dimensionally stable tarpaulin which is more cost efficient. The amount of crimp will be reduced to a minimum.

In a second aspect, the present invention provides a laid fabric suitable to be transformed into a tarpaulin obtained by a melting operation as described in claim 19. By melting a sufficient amount of thermoplastic material coating a hermetic and water impermeable sheet can be obtained out of said processed laid fabric. In a third aspect, the present invention comprises a process for the manufacturing of a tarpaulin using a laid fabric, comprising the following subsequent steps:
constructing a first web layer by guiding and pretensioning a number of mutually parallel reinforcement threads between fixing points back and forth along a first bias direction;
constructing a second web layer by guiding and pretensioning a number of mutually parallel reinforcement threads between said fixing points back and forth along a second bias direction, preferably whereby in top view the layout of the first web layer forms a flipped image of the layout of the second web layer across an axis in the longitudinal direction of the laid fabric;
providing at one side of said two web layers a supporting scrim;
knitting said first web layer, said second web layer and said supporting scrim to each other with knitting means;
optionally preheating or pre-adhering said laid fabric;
melting said thermoplastic material by heating or calendering said laid fabric, whereby a tarpaulin sheet is obtained;
optionally providing one or more finishing coatings on at least one side of the combination of the reinforcement layer and/or one or more secondary coatings as obtained by executing the previous steps;
   as described in claim 20. The process will provide a more dimensionally stable tarpaulin with a higher rigidity together with a more cost efficient manufacturing process.

### DESCRIPTION OF FIGURES

FIG. 1 represents a bottom view of a roof construction of a truck as known from the prior art provided with a tarpaulin. The roof construction is provided with separate reinforcement threads which connect the attachment points at two opposite sides of the construction with each other in two bias directions.

FIG. 2 up to 5 illustrate bottom views of roof constructions of trucks which are covered with several embodiments of tarpaulins.

FIG. 6 illustrates a crossbeam or roof bow on which reinforcement threads, and hence a tarpaulin reinforcement means can be attached.

FIG. 7 is a schematical view of a laid fabric according to an embodiment of the invention.

FIG. 8 is a top view on a laid fabric according to an embodiment of the invention.

FIG. 9 is a schematical view of a laid fabric according to an embodiment of the invention.

FIG. 10 is a top view on a laid fabric according to an embodiment of the invention.

### DETAILED DESCRIPTION OF THE INVENTION

Along the text “polyvinyl chloride (PVC) curtain” and “polyvinyl chloride curtain” fabric are used to refer to a tarpaulin as provided by the invention.

The terms “reinforcement threads” or “reinforcement elements” or “reinforcement means” are used herein as synonyms.

The terms “crossbeam” and “roof bow” are used herein as synonyms.

The term “scrim” as used herein is to be understood as a woven mesh or grid, comprising openings, preferably determined by threads in warp and weft directions.

In one aspect, the present invention comprises a tarpaulin, comprising at least two web layers of reinforcement elements which extend mutually parallel in each web layer, preferably the bias directions of reinforcement elements in said two web layers are mutually opposite, preferably on the one hand at an angle between 0° and 90°, and on the other hand between −90° and 0° with regard to the longitudinal direction of the laid fabric, wherein said reinforcement elements are provided with a thermoplastic material coating.

This is advantageous since the presence of the web layers coated with a thermoplastic material will make the laid fabric suitable to be transformed into a tarpaulin, which is more cost efficient and has a sufficiently high rigidity.

In a preferred embodiment, said laid fabric comprises a supporting scrim provided at one side of said two web layers.

This is advantageous since the presence of the web layers coated with a thermoplastic material will make the laid fabric suitable to be transformed into a tarpaulin, which is more cost efficient and has a sufficiently high rigidity because of the supporting scrim. The amount of crimp will be reduced to a minimum.

In a preferred embodiment, said supporting scrim comprises fibers selected from the group consisting of glass fiber, aramid fiber, para-aramid fiber, basalt, Dyneema® (DSM), Vectran®(Vectran Fiber Inc.), PEEK® (Victrex), PEK® (Solvay), carbon, low-shrink polyester fiber or a combination thereof, preferably polyester fiber.

In a preferred embodiment, said fibers of said supporting scrim are coated with said thermoplastic material.

This will provide a more sufficient amount of thermoplastic material in order to make a more hermetic and water impermeable tarpaulin sheet.

In a more preferred embodiment, all reinforcement elements of said web layers and all fibers of said supporting scrim are provided with the same thermoplastic material, more preferably all reinforcement elements of said web layers are provided with polyvinyl chloride.

In a more preferred embodiment, said thermoplastic material of said supporting scrim and/or of said reinforcement elements is selected out of the group consisting of polyethylene, copolymers of ethylene with vinyl acetate, polypropylene, polystyrene, styrene copolymers, polymethacrylates, polyamides, aliphatic polyester resins, aromatic polyester resins, polycarbonates, polyether imides, polysulfones, polyether sulfones, poly(vinyl chloride), poly(vinylidene chloride), poly(vinyl fluoride), poly(vinylidene fluoride), polytetrafluoroethylene, ethylene-trichlorofluoroethylene copolymers, polyacetals, ABS, SAN, poly(methylmethacrylate), polyamide 6, polyamide 6,6, polyamide 4,6, polyamide 12, polyamide 11, poly(ethylene-terephthalate), poly(butylene terephthalate), poly(ethylene naphthalene dicarboxylate), polyarylates, and thermotropic liquid-crystal polyesters, preferable said thermoplastic material is polyvinyl chloride.

In a preferred embodiment, the reinforcement elements of said web layers and/or the fibers of said supporting scrim are provided with two or more thermoplastic materials, which have chemically and physically compatible properties. This is advantageous for a good thermoplastic behaviour of said two or more materials together in the process to transform the laid fabric into a tarpaulin. In a preferred embodiment, said two web layers and said supporting scrim are knitted together with knitting means, preferably comprising non-crimp yarn such as aramid or polyester yarn.

The knitting means are knitting yarns preferably PET yarn and more preferably aramid yarn. The advantage of using aramid yarns is that they are non-crimp and very strong.

The angle of the layout of the layers should not change during the transformation of the laid fabric into the tarpaulin. The presence of said supporting scrim will fixate and cause less alteration of the layout of the reinforcement means by knitting said two web layers and said supporting scrim together with knitting means.

Alteration of the layout means that reinforcement threads are not completely straight and parallel any more in the layout. This would be a problem, because the threads would not function as quickly as a reinforcement because when the roof is under tension by lateral forces, the threads would first be stretched before they would function as a stabilization element. This would reduce the efficiency of the stabilization function.

The combination of at least two web layers is designed to optimally reinforce the roof construction of the trailer. Preferably, the first and second bias directions of a web layer are symmetrically opposite, i.e. if the first bias direction forms an angle X° with the longitudinal direction (wherein X ranges between 0° and 90°, but is not 0° and 90°), then the second bias direction forms an angle −X° with the longitudinal direction. This will improve dimensional stability of the tarpaulin at a later stage.

In a preferred embodiment, the reinforcement means may be reinforcement means as disclosed in WO 2007/110762.

As bi-axial reinforcement threads may connect the two crossbeams of the frame directly or indirectly to each other and preferably also to the front and the back of the frame, the forces are better absorbed and dispersed. The current material wherein, for example, angles of 60° and −60°, or preferably between −45° and −55°, and between 45° and 55° of the bias threads with regard to the longitudinal direction is provided, will already suffice to at least partly prevent deformation problems.

A reinforcement element is by preference provided in two bias directions, more preferably on the one hand they extend at an angle between 20° and 80°, preferably between 35° and 75°, more by preference between 45° and 55° and on the other hand the reinforcement threads extend at an angle between −20° and −80°, preferably between −35° and −75° and more by preference between −45° and −55°, with respect to the longitudinal direction of the laid fabric.

In a preferred embodiment, a first bias direction of a first web layer of reinforcement elements is provided at an angle smaller than 90°, and more preferably at an angle which is equal to, for example, 85°, 80°, 75°, 70°, 65°, 60°, 55°, 50°, 45°, 40°, 35°, 30°, 25°, 20°, 15° or 10° and wherein a second bias direction of a second web layer of reinforcement elements is provided at an angle greater than −90°, and more preferably at an angle which is equal to, for example, −85°, −80°, −75°, −70°, −65°, −60°, −55°, −50°, −45°, −40°, −35°, −30°, −25°, −20°, −15° or −10°.

In a more preferred embodiment, the web layers of reinforcement elements are provided in two bias directions, preferably two mutually opposite bias directions, preferably in a first web layer at an angle between 45° and 55° and in a second web layer between −45° and −55°.

In a preferred embodiment, said laid fabric comprises a third web layer of reinforcement elements which extend mutually parallel, preferably the bias direction of said reinforcement elements in said web layer is at an angle about 90° with regard to the longitudinal direction of the laid fabric, wherein the reinforcement elements forming said web layers are coated with a thermoplastic material.

In a preferred embodiment, said laid fabric comprises a fourth web layer of reinforcement elements which extend mutually parallel, preferably the bias direction of said reinforcement elements in said web layer is at an angle about 0° with regard to the longitudinal direction of the laid fabric, wherein the reinforcement elements forming said web layers are coated with a thermoplastic material.

In a preferred embodiment, the reinforcement elements of at least one web layer comprise fibers selected from the group consisting of glass fiber, aramid fiber, para-aramid fiber, basalt, Dyneema® (DSM), Vectran®(Vectran Fiber Inc.), PEEK® (Victrex), PEK® (Solvay), carbon, low-shrink polyester fiber or a combination thereof.

The fibers may for example be 100% aramid fibers, 100% glass fibers or 100% polyester fibers.

In order to satisfy to the desired properties, such as being as flexible as possible, being as light-weighted as possible, preferably not rusting, strength, and high resistance against elongation, certain materials will be preferred for the reinforcement means. For example, mono-steel wires of e.g. 0.22 mm in diameter with 6 wires per inch in both directions (bias-) may already suffice. It goes without saying that also materials other than steel may be used in pure or in mixed form. In order to prevent possible corrosion, for example (galvanized) steel wires may be replaced by inox steel wires.

Preferably, the elongation at break will be as small as possible, and preferably less than 10% and still more preferably less than 4%, otherwise the threads need to be overdimensioned to have sufficient resistance against elongation at a given load. A construction with longitudinal threads will also aid in this, especially since these threads connect the front of the frame to the back panel and especially if the elongation of these threads is not more than the elongation of the cross bars. Most preferably (para-) aramid filaments are used with an elongation at break of about 3.5% and with a tensile strength of about 350 N.

These reinforcement threads may also be replaced wholly or partly, optionally as a combination, by aramid filaments, preferably para-aramid filaments, carbon fibers or wires, glass or Rockwool such as basalt, Vectran® (Vectran Fiber Inc.), carbon fiber, Dyneema® (DSM), INOX, PEEK® (Victrex), PEK (Solvay) and others in all possible combinations in yarn composition, continuous or stretched wires, combinations in yarn shape, in twists or cables, twines, etc. and all possible textile shapes such as bands, braids, fabrics, knittings, layouts, non-wovens, etc.

More preferably, the reinforcement threads will be used with a spin finish compatible with the PVC compound, this will result in a better adhesion with the PVC. An example of a suitable reinforcement thread is Twaron® type 1014 by Teijin, which is an adhesion-activated yarn.

More preferably, the fibers are aramid and/or glass fibers. This has the additional advantage that the laid fabric is protected against the destructive action of sparks falling off the overhead electric lines, when a trailer covered by said fabric is carried on a railway carriage.

In a more preferred embodiment, the reinforcement elements of a first web layer comprise aramid fibers and the reinforcement elements of a second web layer comprise polyester fibers.

In a more preferred embodiment, the reinforcement elements of a first web layer comprise fibers which are in the first place cheap but strong, preferably polyester fibers or similar, and the reinforcement elements of a second web layer comprise fibers which are strong and stable, i.e. low-shrink, low-expansion fibers which remain stable under varying temperatures to which the fabric can be exposed during manufacturing or usage of the tarpaulin, preferably glass fibers. Using strong and/or dimensionally stable fibers is advantageous as it avoids bending or curling at the side edges due to e.g. shrinkage and/or expansion of the fibers under variable temperature and tension conditions during manufacturing or use.

In a more preferred embodiment, a web layer comprises reinforcement elements of different fibers. In a most preferred embodiment, a web layer comprises at the one hand reinforcement elements of fibers which are in the first place cheap but strong, preferably polyester fibers or similar, and at the other hand reinforcement elements of fibers which are strong and stable, i.e. low-shrink, low-expansion fibers which remain stable under varying temperatures to which the fabric can be exposed during manufacturing or usage of the tarpaulin, preferably glass fibers. Using strong and/or dimensionally stable fibers is advantageous as it avoids bending or curling at the side edges due to e.g. shrinkage and/or expansion of the fibers under variable temperature and tension conditions during manufacturing or use.

In a more preferred embodiment, the reinforcement elements are composite threads, preferably consisting of a thermoplastic sheath covering roving of said fibers.

These composite threads can be obtained by several techniques such as dipcoating, coextrusion, poltrusion, pultrusion, filament winding, molding, welding, reinforcing, etc.

In an even more preferred embodiment, said composite threads are obtained by a dipcoating technique.

This is advantageous as despite less thicker thermoplastic sheaths, these sheaths will melt more easily to other layers.

In an even more preferred embodiment, said thermoplastic sheath is preferably selected out of the group consisting of polyethylene, copolymers of ethylene with vinyl acetate, polypropylene, polystyrene, styrene copolymers, polymethacrylates, polyamides, aliphatic polyester resins, aromatic polyester resins, polycarbonates, polyether imides, polysulfones, polyether sulfones, poly(vinyl chloride), poly(vinylidene chloride), poly(vinyl fluoride), poly(vinylidene fluoride), polytetrafluoroethylene, ethylene-trichlorofluoroethylene copolymers, polyacetals, ABS, SAN, poly(methylmethacrylate), polyamide 6, polyamide 6,6, polyamide 4,6, polyamide 12, polyamide 11, poly(ethylene-terephthalate), poly(butylene terephthalate), poly(ethylene naphthalene dicarboxylate), polyarylates, and thermotropic liquid-crystal polyesters, more preferable said thermoplastic material is polyvinyl chloride.

In an even more preferred embodiment, the ratio of said thermoplastic sheath to fiber preferably is between 50% and 95%, more preferably between 60% and 80% and most preferably between 65% and 75% by volume.

In an even more preferred embodiment, the ratio of said thermoplastic sheath to fiber by mass preferably is between 40% and 95%, more preferably between 50% and 80%.

In an even more preferred embodiment, said composite threads are impregnated with thermoplastic powder. The thermoplastic powder will lead to a better adhesion of the thermoplastic sheath. In a most preferred embodiment the thermoplastic powder is preferably selected out of the group consisting of polyethylene, copolymers of ethylene with vinyl acetate, polypropylene, polystyrene, styrene copolymers, polymethacrylates, polyamides, aliphatic polyester resins, aromatic polyester resins, polycarbonates, polyether imides, polysulfones, polyether sulfones, poly(vinyl chloride), poly(vinylidene chloride), poly(vinyl fluoride), poly(vinylidene fluoride), polytetrafluoroethylene, ethylene-trichlorofluoroethylene copolymers and polyacetals, and more preferably is polyvinyl chloride.

In a preferred embodiment, per web layer said reinforcement elements are provided as spaced apart tracks of reinforcement elements wherein the ratio between track width and track interspace preferably is situated between 4% and 90%, more preferably between 5% and 50%, even more preferably between 6% and 35%, most preferably between 7% and 20%.

It is advantageous as this still provides a sufficiently strong and dimensionally stable tarpaulin, together with a more economic tarpaulin as it does not need to be provided with reinforcement elements over the whole length of the tarpaulin.

In a more preferred embodiment, said tracks are provided such that all reinforcement elements can be attached by an anchoring point of roof bows of a roof construction.

This means that the most useful reinforcement elements, i.e. those that mutually connect anchoring points of roof bows, are provided, leading to a sufficiently stable and more economic tarpaulin.

In a more preferred embodiment, said track width according the longitudinal direction of the tarpaulin is preferably situated between 1.0 to 2.0 times the width of the anchoring zone of a roof bow.

With the term “anchoring zone” it is meant that within this zone reinforcement elements can be anchored or attached to a roof bow. Typically said zone can be determined by a plate, a hand, a space between rivets or fastening means.

In a more preferred embodiment, a spaced apart track comprises preferably between 5 to 100, more preferably between 5 to 50, even more preferably between 6 to 25 and most preferably between 6 to 15 reinforcement elements or threads.

In a more preferred embodiment, said reinforcement elements per track are provided non-equidistantly, whereby the mutual distance is lower for more central situated reinforcement elements. In an even more preferred embodiment these reinforcement elements are provided according a predetermined distribution of mutual distance, for example according a Gaussian distribution.

In a second aspect, the present invention comprises a tarpaulin obtained by a melting operation on a laid fabric.

It is advantageous since melting an amount of the present thermoplastic material in said laid fabric will make a tarpaulin that is more hermetic, lighttight and water impermeable together with the better cost efficiency and sufficiently high rigidity.

In a preferred embodiment, the reinforcement elements within each web layer have an average density of at least 3 reinforcement elements per 2.54 cm (inch), preferably at least 8 reinforcement elements per 2.54 cm (inch), more preferably at least 10 reinforcement elements per 2.54 cm (inch), at most 20 reinforcement elements per 2.54 cm (inch), preferably at most 16 reinforcement elements per 2.54 cm (inch), more preferably at most 14 reinforcement elements per 2.54 cm (inch), most preferably about 12, wherein the density is measured in the longitudinal direction of the laid fabric.

In a preferred embodiment, the average linear density of the reinforcement elements preferably is between 1500 dtex and 4000 dtex, more preferably between 1600 dtex and 3400 dtex, most preferably about 1680 dtex or 3360 dtex.

In a preferred embodiment, the average linear density of the core of the reinforcement elements preferably is between 1500 dtex and 3500 dtex, more preferably between 1600 dtex and 1800 dtex, most preferably about 1680 dtex or 1740 dtex.

With the term “core” of a reinforcement element is meant, the reinforcement element without said thermoplastic coating.

In a preferred embodiment, the elastic modulus of the core of the reinforcement elements preferably is between 60 GPa and 105 GPa, more preferably between 70 GPa and 95 GPa, most preferably about 72 GPa, 82 GPa or 92 GPa.

In a preferred embodiment, the average area density of said tarpaulin is preferably between 400 g/m² and 900 g/m², more preferably between 500 g/m² and 700 g/m² and most preferably between 600 g/m² and 660 g/m².

In a preferred embodiment, a water impermeable coating is provided on at least one side of said tarpaulin, preferably on the scrim side.

In a preferred embodiment, a secondary coating is provided preferably consisting of a polyvinyl chloride coating, which is preferably provided on the exterior and/or the interior of the tarpaulin. Preferably, the coating on the exterior of the tarpaulin may be impermeable. Preferably, this coating may be UV-durable and dirt resistant. This coating may have several colors, for example white, yellow, etc. Preferably, the coating on the interior of the tarpaulin may be impermeable. This coating may have several colors or preferably, may be transparent to allow to pass as much light as possible through the roof construction inside the freight truck, and to leave visible as much as possible the reinforcement elements for assembling on the anchoring points and/or for observing the angle under which the reinforcement means are applied and/or for observing other possible markers or colors or identification means applied to the reinforcement and/or knitting means. For example, a coating may be a thin layer, for example a film or a foil, of lacquer or extruded plastic, for example of a thermoplastic material, preferably PVC.

In a preferred embodiment, said thermoplastic coating has several colors or identification means. This is advantageous in order to observe the angle or direction under which the reinforcement means are applied.

In a preferred embodiment, a finishing coating is provided on at least one side. More preferably the reinforcement elements are used with a spin finish compatible with the possible intermediate coating and/or a polyvinyl chloride compound, to create a good adhesion between the reinforcement elements and the coatings and also to avoid polyvinyl chloride delamination problems. More preferably, a finishing coating is preferably applied, more preferably a lacquer coating, on at least one side of the polyvinyl chloride curtain fabric in order to protect it from UV radiations, water intrusion and dirt. More preferably, the finishing coating is at least water impermeable, UV-radiation resistant and dirt resistant.

Insuring the reinforcement means by knitting means may result in holes. Therefore, to seal the tarpaulin and to further strengthen the tarpaulin, one or more polyvinyl chloride coatings may be applied on at least one and preferably both sides of the obtained tarpaulin. In a preferred embodiment the fibers of the reinforcement means comprise a spin finish compatible with the coating applied to them. Preferably, a lacquer coating is applied on at least one side of the obtained construction in order to protect it from UV radiations, dirt and water intrusion.

In a third aspect, the present invention comprises a process for the manufacturing of a tarpaulin using a laid fabric, comprising the following subsequent steps:
constructing a first web layer by guiding and pretensioning a number of mutually parallel reinforcement threads between fixing points back and forth along a first bias direction;
constructing a second web layer by guiding and pretensioning a number of mutually parallel reinforcement threads between said fixing points back and forth along a second bias direction, preferably whereby in top view the layout of the first web layer forms a flipped image of the layout of the second web layer across an axis in the longitudinal direction of the laid fabric;
providing at one side of said two web layers a supporting scrim;
knitting said first web layer, said second web layer and said supporting scrim to each other with knitting means;
optionally preheating or pre-adhering said laid fabric;
melting said thermoplastic material by heating or calendering said laid fabric, whereby a tarpaulin sheet is obtained;
optionally providing one or more finishing coatings on at least one side of the combination of the reinforcement layer and/or one or more secondary coatings as obtained by executing the previous steps.

In a preferred embodiment, the construction of a web layer happens as follows. A fixed number of bobbins provide a corresponding number of individual reinforcement threads, which run mutually parallel. The parallel threads are guided back and forth between two parallel rows of fixing points, where between the reinforcement threads are pretensioned. One thread between two fixing points corresponds to a reinforcement element. The two fixing points will determine the angle of reinforcement element with respect to the longitudinal direction of the laid fabric. In a more preferred embodiment, two rows of fixing points are provided by two parallel chains comprising hooks, which chains run in said longitudinal direction.

In a preferred embodiment, the number of provided parallel reinforcement threads is preferably between 10 and 100, more preferably between 20 and 80, most preferably between 25 and 60.

The first web layer forms a flipped image of the layout of the second web layer across an axis in the longitudinal direction of the laid fabric. Preferably, a preheating step or adhering step is executed to make the thermoplastic coating fixing the threads, so that the fixing means can be removed and the tension within the reinforcement means is kept. In a more preferred embodiment, the sides of the laid fabric with the fixing means are cut off.

Then, a supporting scrim is provided at one side of said two web layers. Said first web layer, said second web layer and said supporting scrim are knitted to each other by knitting means.

Said laid fabric is heated in an oven, UV-heated or calendered so that the thermoplastic coating flows and seals the laid fabric into a tarpaulin sheet. Preferably the amount of thermoplastic coating is sufficient to obtain a hermetic and water impermeable sheet out of the processed laid fabric.

In a preferred embodiment, said process comprises the following step:
providing one or more secondary coatings on at least one and preferably both sides of said laid fabric.

In a more preferred embodiment, said one or more secondary coatings comprise an “extrusion” coating.

The term “extrusion coating” as used herein is to be understood as a coating step wherein two rollers are placed vertically one above the other and at an adjustable distance from each other, corresponding to a certain coating thickness, wherein liquid thermoplastic material is provided onto the tarpaulin sheet and then this tarpaulin sheet with said thermoplastic material is run between said two rollers.

It is advantageous as it provides a more flat and therefore clean surface on the top side of the tarpaulin. This coating step prevents to get a potential non-flat tarpaulin caused by e.g. eventual holes or cavities between the threads of the biaxial web layers of said laid fabric. Irregularities in the flatness of a tarpaulin can give rise to accumulating dirt, so a more flat tarpaulin sheet is desirable. By applying this coating a more dimensional stable sheet will be obtained. Also a flat surface of said tarpaulin sheet is advantageous as it will provide a uniform distribution of further coatings, such as e.g. a lacquer coating.

In a more preferred embodiment, said one or more secondary coatings comprise a thermoplastic film coating.

The term “thermoplastic film coating” as used herein is to be understood as a coating step wherein a film or thin layer of thermoplastic material is provided at one or both sides of said tarpaulin sheet. In order to be able to attach, one side of said film can be subjected to a melting step, wherein said side of said film is partially melted.

It is advantageous as it provides a more flat and therefore clean surface on the top side of the tarpaulin. Also a flat surface of said tarpaulin sheet is advantageous as it will provide a uniform distribution of further coatings, such as e.g. a lacquer coating.

In a more preferred embodiment, said one or more secondary coatings comprise a “knife-over-roll” coating.

It is advantageous to flatten the tarpaulin surface even more in order to obtain a clean and dimensionally stable tarpaulin sheet.

In a preferred embodiment, said process comprises the following step:
providing one or more finishing coatings on at least one side of said laid fabric.

More preferably, a lacquer coating is applied on at least one side of the tarpaulin in order to protect it from UV radiations, water intrusion and dirt.

More preferably, the finishing coating is at least water impermeable, UV-radiation resistant and dirt resistant.

Preferably, the present tarpaulin is an upper tarpaulin (or top tarpaulin), i.e. a tarpaulin suitable to cover the top of a freight truck, trailer or truck or the like. However, the present tarpaulin may also comprise a tarpaulin suitable to cover the sidewall(s) of a freight truck, trailer or truck. In a further embodiment the invention provides the use of a tarpaulin according to the invention as a stabilizer against the deformation of freight trucks, trailers and/or trucks. Preferably, said vehicle is provided with a multiple of roof bows, wherein a bias direction is determined as parallel to the connection line between the anchoring point on one roof bow and the diagonally opposed anchoring point on a next roof bow.

In a fourth aspect, the present invention comprises the use of a tarpaulin as a stabilizer against the deformation of freight trucks, trailers and/or trucks. In another embodiment the invention provides the use of a tarpaulin according to the invention as a reinforcement means and/or anti-vandalism material. It has been found by the inventor that the tarpaulin according to the current invention is very effective in stabilizing the load of a freight truck during transport, even though the tarpaulin shows high flexibility. This flexibility allows for the use of the tarpaulin according to this invention in a curtain-like setup whereby the tarpaulin can be folded and stretched multiple times without losing stabilizing capacities. In said setup, the roof curtain can be folded, together with a sliding roof system, with the advantage that no reinforcement cables are hanging in the loading space of the trailer when the roof is opened.

In a preferred embodiment, the vehicle is provided with a multiple of roof bows, and wherein a bias direction is determined as parallel to the connection line between the anchoring point on one roof bow and the diagonally opposed anchoring point on a next roof bow.

In a more preferred embodiment, on each anchoring point at least 3 reinforcement elements are clenched.

In a preferred embodiment, a tarpaulin may be attached to the roof construction of a freight truck, trailer and/or truck in anchoring points. Said roof construction may comprise at least two or more crossbeams, for example, 2, 3, 4, 5, 6, 7, 8, 9, 10, 20, 30, 50, 100 or any value comprised between two of the aforementioned values.

Preferably, the reinforced tarpaulin according to the invention is attached to all possible anchoring points (attachment points) provided in the roof construction of the vehicle. Therefore, the attachment is preferably carried out on all possible attachment points, which may reduce or even prevent a possible deformation of the horizontal crossbeams.

### FIGURES

In order to better show the features of the invention, hereafter, by way of example and without any limiting purpose, some preferred embodiments are described.

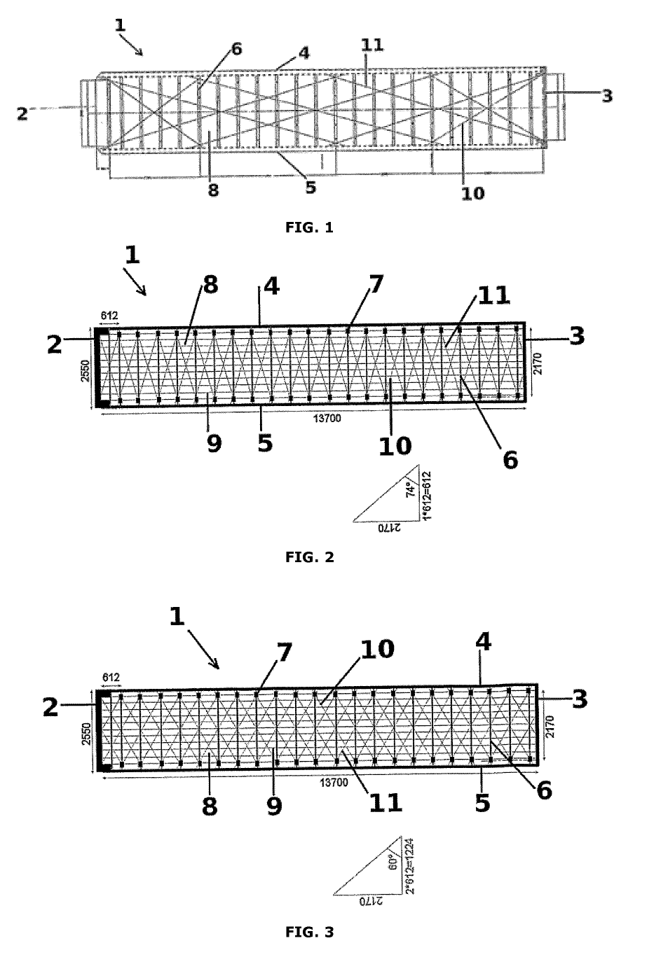

FIGS. 2-5 illustrate a construction as specified in WO 2007/110762 which has only reinforcements in bias-form in the construction or composite in the sense that the attachment points on the horizontal joints of the crossbeams or on the crossbeams themselves are diagonally (in bias) connected with each other. The (textile) product may also have only threads in these connection areas, but may also have a regular construction. The reinforcement construction may also only consist of a longitudinal reinforcement (angle 0° or preferably less than 45°). A still more preferred construction will consist of a material with a bias reinforcement, different from 0° and/or 90°, and with a longitudinal reinforcement of preferably 0°. These longitudinal threads will connect the front plate and the rear plate or front and rear rail of a vehicle directly or indirectly to each other and also contribute against the deformation of the trailer and/or vehicle. FIGS. 2-5 illustrate roof constructions (1) for freight trucks, trailers or trucks. The roof constructions comprise a rectangular frame (frame), consisting of two short sides (2, 3) (also called top beams or front and rear rail), and two sides which extend in the longitudinal direction (4, 5) (also called upper beams or longitudinal rails). The sides (4, 5) which extend in the longitudinal direction are mutually connected by means of crossbeams or roof bows (6), the crossbeams being provided with anchoring points (7) for anchoring a tarpaulin (8) to the roof construction. As explained above, the tarpaulin (8) comprises a tarpaulin reinforcement means comprising a layout of reinforcement threads (9, 10, 11). These reinforcement threads are provided in three directions: reinforcement threads (9) are provided in the longitudinal direction, and reinforcement threads (10, 11) are provided in two bias directions. The reinforcement threads (9, 10, 11) connect all possible anchoring points (7) provided on the roof bows (6). For comparison, reinforcement threads (10, 11) provided for tarpaulins (8) known from the prior art, as illustrated in FIG. 1, are provided in two (bias) directions, but not in the longitudinal direction, and do not connect all possible anchoring points. These prior art examples of, in particular, the configurations of the reinforcement means can be used in the tarpaulin construction according to the present invention.

Therefore, in an embodiment, the invention provides also the use of a tarpaulin as described herein, as a roof covering for a vehicle, wherein the vehicle is provided with multiple roof bows (6), and wherein one (or several) bias directions is (are) determined as parallel to the connection line between the anchoring point (7) on one roof bow (6) and the diagonally opposite anchoring point (7) on another (for example a next or a further, for example a second next, third next, fourth next, or fifth next, etc.) roof bow (6). Therefore, the two anchoring points (7) connected by the connection line are located at opposed sides (4) or (5) of the roof construction. Preferably, such a connection line is drawn when the respective roof bows (6) are in a closed roof configuration.

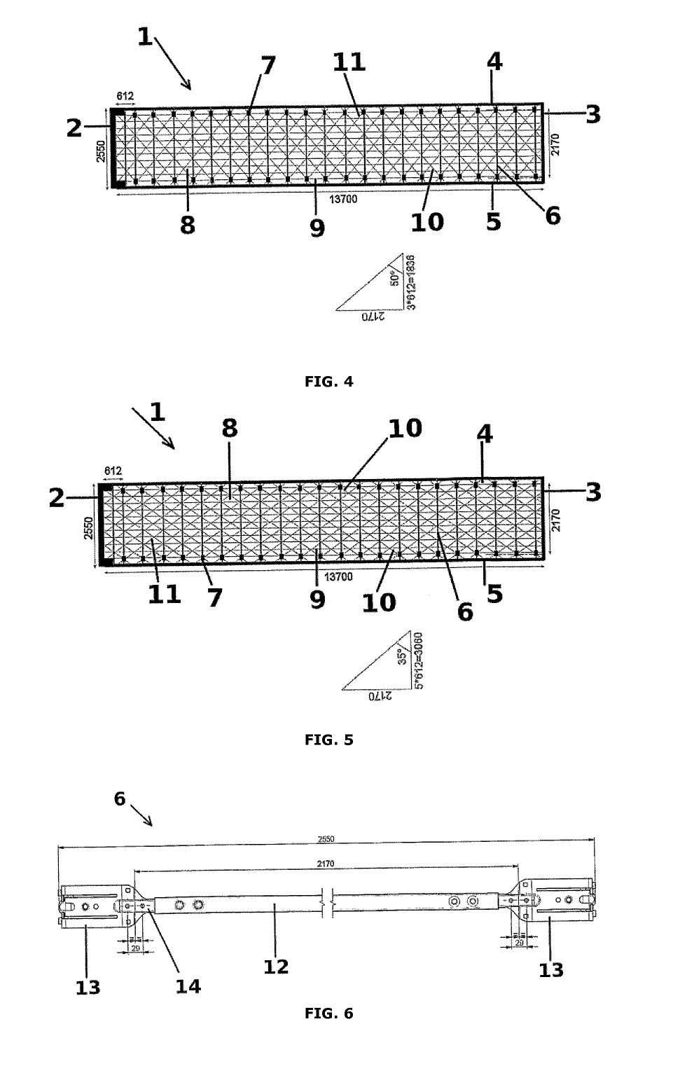

FIG. 6 illustrates a roof bow (6) to which the reinforcement threads of a tarpaulin reinforcement means or a tarpaulin according to the invention are attached. Such a roof bow is usually provided with a crossbeam (12) provided at its end with hands (13). The hands (13) are attached to the crossbeam (12) near the plate (7) serving as an anchoring point. Preferably, the reinforcement threads of a tarpaulin reinforcement means or a tarpaulin according to the invention are attached to plate (14), for example by means of screws or rivets. In another embodiment of the invention, the tarpaulin is attached to the lateral upstanding exterior side of the hand (13) by means of screws or rivets.

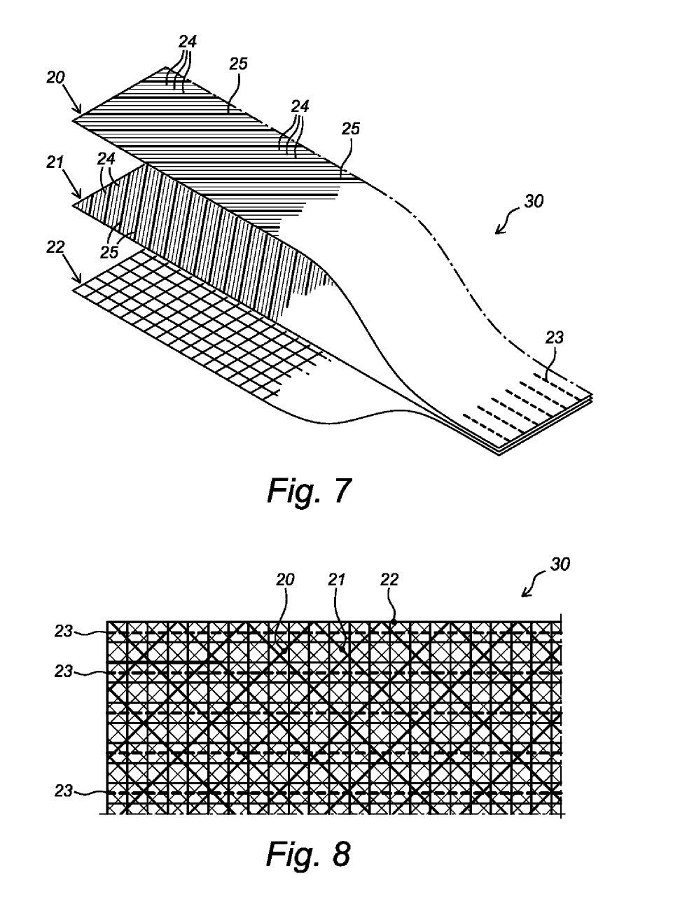

FIG. 7 is a schematical view of a laid fabric (30) according to an embodiment of the invention. The construction of this laid fabric (30) comprises two web layers (20, 21) and a supporting scrim (22) provided at one side of said two web layers (20, 21). These web layers (20, 21) and scrim (22) are knitted together by knitting means (23) to obtain a fixated laid fabric which is suitable to be transformed into a tarpaulin (8).

The first web layer (20) comprises reinforcement elements (24, 25) which extend mutually parallel at 45° with regard to the longitudinal direction of the laid fabric (30). The second web layer (21) also comprises reinforcement elements (24, 25) which extend mutually parallel, but with the opposite bias direction i.e. at −45° with regard to the longitudinal direction of the laid fabric (30). For both web layers (20, 21) said reinforcement elements (24, 25) consist of alternating 3 threads (24) of polyester and 1 thread (25) of aramide. These threads are provided with a thermoplastic material coating according to the present invention. FIG. 8 shows a top view on said laid fabric (30).

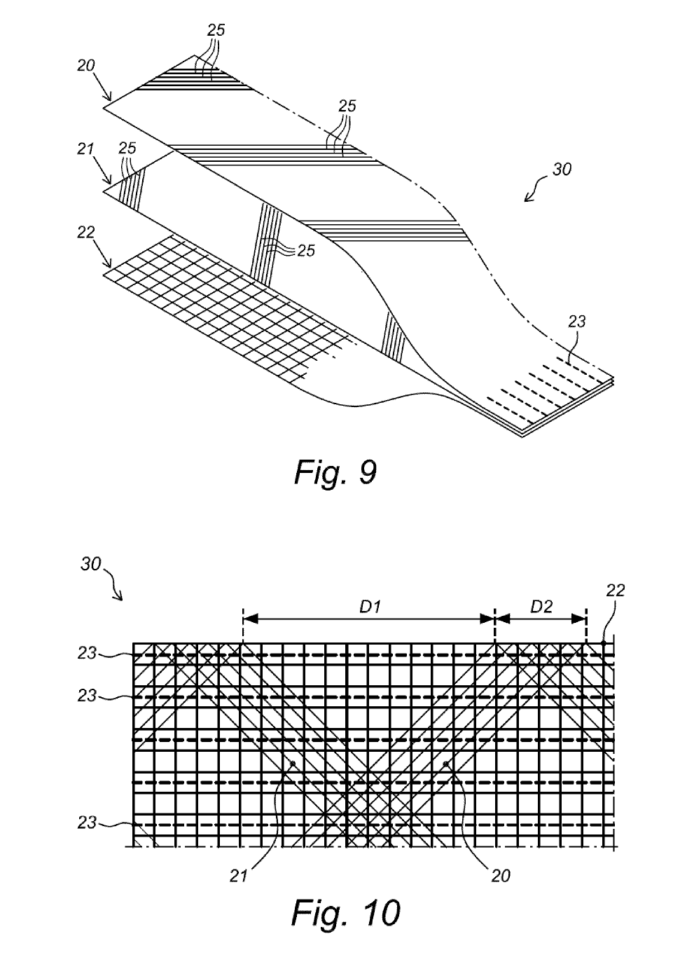

FIG. 9 is a schematical view of a laid fabric (30) according to an embodiment of the invention. The construction of this laid fabric (30) comprises two web layers (20, 21) and a supporting scrim (22) provided at one side of said two web layers (20, 21). These web layers (20, 21) and scrim (22) are knitted together by knitting means (23) to obtain a fixated laid fabric which is suitable to be transformed into a tarpaulin (8). The first web layer (20) comprises reinforcement elements (25) which extend mutually parallel at 45° with regard to the longitudinal direction of the laid fabric (30). The second web layer (21) also comprises reinforcement elements (25) which extend mutually parallel, but with the opposite bias direction i.e. at −45° with regard to the longitudinal direction of the laid fabric (30). For both web layers (20, 21) said reinforcement elements consist of spaced apart tracks of threads. Each track comprises 6 parallel threads (25) of aramide. These threads are provided with a thermoplastic material coating according to the present invention.

FIG. 10 shows a top view on said laid fabric (30). In a preferred embodiment of the invention, the ratio between track width and track interspace (D2/D1) is situated between 4% and 90%, more preferably between 5% and 50%, even more preferably between 6% and 35%, most preferably between 7% and 20%. Preferably, the track width D2 according the longitudinal direction of the tarpaulin is situated between 1.0 to 2.0 times the width of the anchoring zone of a roof bow.

### EXAMPLES

The examples related to the reinforcement means disclosed in WO 2007/110762, apply also to the laid fabric and/or tarpaulin according to the present invention. The following examples illustrate some preferred constructions of tarpaulin reinforcement means according to the invention.

For the reinforcement means, some examples are given in the following:

### Example 1

### A Multi-Axial Reinforcement

1.1 in bias direction +49° and −49°; 3 threads per inch of aramid 1680 dtex regularly spread out over the full surface; 6 threads per inch of polyester 1670 dtex regularly spread out over the full surface. Every 5 inch a red PET yarn is inserted as a marker
1.2 in longitudinal direction 0°-1 threads of aramid 1680 dtex per 2.5 cm
1.3 knitting yarn: 167 dtex PES FTF.

### Example 2

### A Multi-Axial Reinforcement

2.1 in bias direction +52° and −52°; 3 threads per inch of aramid 2500 dtex regularly spread out over the full surface; 9 threads per inch of polyester 1670 dtex regularly spread out over the full surface. Every 5 inch a black PET yarn is inserted as a marker
2.2 knitting yarn: 167/2 dtex PES FTF.

### Example 3

### A Multi-Axial Reinforcement

3.1 in bias direction +48° and −48°; 3 threads per inch of aramid 3360 dtex regularly spread out over the full surface; 6 threads per inch of glass 1680 dtex regularly spread out over the full surface. Every 5 inch a blue PET yarn is inserted as a marker
3.2 in longitudinal direction 0°-3 threads of aramid 3360 dtex per 2.5 cm
3.3 knitting yarn: 167/2 dtex PES FTF.

### Example 4

### A Multi-Axial Reinforcement

4.1 in bias direction +45° and −45°; 3 threads per inch of glass 134 tex regularly spread out over the full surface; 1 thread per inch of aramid 1680 dtex regularly spread out over the full surface.

### Example 5

### A Supporting Scrim

5.1 in warp direction 2.8±0.5 threads per cm of PES (polyester) 1100 dtex.
5.2 in weft direction 1.5±0.5 threads per cm of PES (polyester) 1100 dtex.
5.3 weight density of 160±15 g/m².

In an embodiment, the color of the fiber of the marker gives an indication of the bias of the reinforcement threads. For example: a black fiber indicates a bias of the threads with the longitudinal direction comprised between 50°-54°, a red fiber 48°-50° and a blue fiber 45°-48°.

And these examples of the reinforcement means can be used in combination with e.g. one or more impermeable opaque PVC outer coatings, one or more impermeable transparent PVC inner coatings, a UV-resistant PVC outer finishing coating.

An infinite number of variations is possible with parameters such as type of wire, density, angles, materials, weights, types of coatings, etc. The reinforcement threads may also be replaced and/or mixed with ropes, twines, cables, tapes, multi-filaments, etc. It is self-evident that one or more of these parameters as shown in WO/2007/110762 and in the not yet published application PCT/EP2011/066881 (filed on Sep. 28, 2011) can also be implemented in the present invention. It is self-evident that multi-axial layouts of laid fabrics also form subject matter of the present invention.

1-20. (canceled)

21. Tarpaulin, comprising at least two web layers of reinforcement elements which extend mutually parallel in each web layer, wherein the bias directions of reinforcement elements in said two web layers are mutually opposite, and wherein said reinforcement elements per web layer are provided as spaced apart tracks of reinforcement elements, and wherein the ratio D2/D1 between track width and track interspace is between 4% and 90%.

22. Tarpaulin according to claim 21, wherein said reinforcement elements are provided with a thermoplastic material coating and/or wherein the bias directions of reinforcement elements in said two web layers are mutually opposite on the one hand at an angle between 0° and 90°, and on the other hand between −90° and 0° with regard to the longitudinal direction of a laid fabric.

23. Tarpaulin according to claim 22, wherein said laid fabric comprises a supporting scrim provided at one side of said two web layers.

24. Tarpaulin according to claim 23, wherein said supporting scrim comprises polyester fibers and/or, wherein said fibers of said supporting scrim are coated with said thermoplastic material.

25. Tarpaulin according to claim 22, wherein said thermoplastic material is polyvinyl chloride.

26. Tarpaulin according to claim 23, wherein said two web layers and said supporting scrim are knitted together with knitting means.

27. Tarpaulin according to claim 21, wherein a first bias direction of a first web layer of reinforcement elements is provided at an angle smaller than 90° and wherein a second bias direction of a second web layer of reinforcement elements is provided at an angle greater than −90° and/or wherein the web layers of reinforcement elements are provided in two bias directions.

28. Tarpaulin according to claim 21, wherein the reinforcement elements of at least one web layer comprise fibers selected from the group consisting of glass fiber, aramid fiber, para-aramid fiber and polyester fiber or wherein the reinforcement elements of a first web layer comprise aramid fibers and wherein the reinforcement elements of a second web layer comprise polyester fibers.

29. Tarpaulin according to claim 21, wherein a web layer comprises reinforcement elements of different fibers and/or wherein the reinforcement elements are composite threads, preferably consisting of a thermoplastic sheath covering roving of said fibers.

30. Tarpaulin according to claim 29, wherein said thermoplastic sheath consists of polyvinyl chloride and/or wherein said composite threads are impregnated with thermoplastic powder.

31. Tarpaulin according to claim 22, wherein the reinforcement elements within each web layer have an average density of at least 3 reinforcement elements per 2.54 cm, at most 20 reinforcement elements per 2.54 cm, wherein the density is measured in the longitudinal direction of the laid fabric.

32. Tarpaulin according to claim 21, wherein a water impermeable coating is provided on at least one side of said tarpaulin and/or wherein a finishing coating is provided on at least one side.

33. Laid fabric suitable to be transformed into a tarpaulin according to claim 21.

34. Process for the manufacturing of a tarpaulin according to claim 21 using a laid fabric, comprising the following subsequent steps:
constructing a first web layer by guiding and pretensioning a number of mutually parallel reinforcement threads between fixing points back and forth along a first bias direction;
constructing a second web layer by guiding and pretensioning a number of mutually parallel reinforcement threads between said fixing points back and forth along a second bias direction;
providing at one side of said two web layers a supporting scrim;
knitting said first web layer, said second web layer and said supporting scrim to each other with knitting means;
optionally preheating or pre-adhering said laid fabric;
melting said thermoplastic material by heating or calendering said laid fabric, whereby a tarpaulin sheet is obtained;
optionally providing one or more finishing coatings on at least one side of the combination of the reinforcement layer and/or one or more secondary coatings as obtained by executing the previous steps;
wherein, said reinforcement elements per web layer are provided as spaced apart tracks of reinforcement elements wherein the ratio D2/D1 between track width and track interspace is between 4% and 90%.

35. Process according to claim 34, whereby in top view the layout of the first web layer forms a flipped image of the layout of the second web layer across an axis in the longitudinal direction of the laid fabric.
